(19) United States
(12) Patent Application Publication
(10) Pub. No.: US 2007/0237920 A1
(43) Pub. Date: Oct. 11, 2007

(54) Method for Manufacturing a Decorative Object with a Shell

(76) Inventor: Philippe Schoulz, Paris (FR)

Correspondence Address: CLARK & BRODY, 1090 VERMONT AVENUE, NW, SUITE 250, WASHINGTON, DC, 20005, US

(21) Appl. No.: 11/578,775

(22) PCT Filed: Apr. 19, 2004
(86) PCT No.: PCT/IB04/01459

§ 371 Date: Oct. 18, 2006

(51) Int. Cl. B44C 5/06

(52) U.S. Cl. 428/67; 264/39

(57) ABSTRACT

In order to greatly increase the decoration, entertainment or advertisement effect of decorative object, the invention proposes to melt a fluid material, like a transparent resin, to a shell so as to obtain a particularly new and eyed-catching ornamental effect. In particular, the present invention relates to a method for manufacturing a decorative object consisting of filling at least one opening (15) of a natural empty shell (10 ) with a fluid material R adapted to harden, like a polymer resin, glass or crystal, said method comprising at least the steps of: —cleaning the shell, —filling the opening(s) with said fluid material, —waiting for the fluid material to harden, —polishing the shell so as to withdraw any external roughness (44).

The present invention relates generally to a method for manufacturing a decorative object with a shell, and particularly for jewellery and fashion accessories.

In the field of decorative objects used for the house like door knob, lamp, offices supplies, in the domain of fashion accessories like bag, belt, or shoes, and in jewellery, it is common to use many kinds of object made of plastic, gold, silver, stainless steel, glass, crystal, or natural objects like shells or pearls.

It is for example well known to use a pearl, or more, as a pendant or ears. It is also possible to give the form of a false shell to a door knob by using a moulded resin.

Besides, there is a need to improve the attraction of the public for theses decorative objects, especially when using a shell as the base object. In itself, even if the shell is beautiful, clean, and very detailed, the decorative object is not very appealing.

In order to greatly increase the decoration, entertainment or advertisement effect of a decorative object based on a shell, the invention proposes a method for melting it with a fluid material which, when hardened, provides a new and very attractive and eyed-catching ornamental effect.

More specifically, the object of the present invention relates to a method for manufacturing a decorative object by filling at least one opening of a natural empty shell with a fluid material adapted to harden, like a polymer resin, glass or crystal, said method comprising at least the steps of:
cleaning the shell,
filling the opening(s) with said fluid material,
waiting for the fluid material to harden,
polishing the shell so as to withdraw any external roughness.

According to preferred embodiments:
the shell is submitted to a bacteriological and/or chemical treatment during the cleaning step.
before filling the opening(s) with the fluid material, the shell is cut and/or openings are drilled in/through the shell so as to obtain a predetermined shape.
openings are engraved on the shell to form a geometric pattern like letters, numbers or the shape of an object or an animal. Preferably, the openings are done with a mini drill, a micro saw, laser, sand blasting erosion or water jet cutting.
the empty cleaned shell having a central shaft corresponding to the central and essentially axial part of the mollusc, the shell is cut so as to create a slice provided with openings, and said openings are filled with the fluid material; In one preferred embodiment, the shell is cut longitudinally along said central shaft so as to create a slice embedding said central shaft and provided with openings disposed around the central shaft, between said central shaft and a peripheral wall. In another embodiment, the shell is cut across said central shaft, preferably essentially perpendicularly, so as to create a slice having a hollow helical shape with a helical opening defined between the central shaft and a peripheral helical wall.
the slice is put into a fluid material pool so that the opening(s) is (are) filled with said fluid material, and the slice is withdrawn from the pool after solidification of the fluid material. In another embodiment, the opening(s) is (are) sealed temporarily by a cover layer made of a material which can resist to the melt temperature of the fluid material, at least one filling port being provided in the shell for filling the opening(&) with the fluid material, the fluid material is poured in the shell through said at least one port, and said cover layer is withdrawn after solidification of the fluid material. Preferably, the cover layer is an adhesive film, a coated woven/unwoven fabric, or paper.
the shell having the shape of a half scallop-shell provided with one large concave opening, the fluid material is filled in the opening by putting said shell into a fluid material pool, and the shell is withdrawn from the pool after solidification of the fluid material.
the shell is externally polished so as to provide a particular decorative and/or geometrical shape, like a heart.
the step of polishing is made manually or mechanically, with a polish machine, grinding stones, polish roller, sand paper or abrasive cloth roller.
in order to accelerate the step of hardening of the fluid material, the shell is put inside a stove at about 60-100° C., preferably 80° C., during approximately 8 to 14 hours, preferably 12 hours. Preferably, dry air is blown inside the stove.
the shell is provided with a support mean for a necklace, for example a hole drilled through the shell and/or the hardened material or a hook embedded in the hardened material.
said fluid material is translucent or totally transparent, so that it is possible to see clearly through said material, especially to see the structure of the shell. Preferably, said fluid material is a transparent polymer resin, for example a melt of a polyether tri-amine, like JEFFAMINE® T-403 and a liquid epoxy resin like EPIKOTE® 828, or glass, or crystal, coloured or not.
the decorative object can be a jewel like a pendant, a ring, ears or a bracelet, a house accessory like a door knob, a lamp, a wind chime, or a fashion accessory adapted for example to be mounted on a shoe, a bag, a backpack, or a belt.

The invention is now detailed in the hereafter description of examples of preferred embodiments of the invention, in reference with the enclosed drawings that represent, respectively:

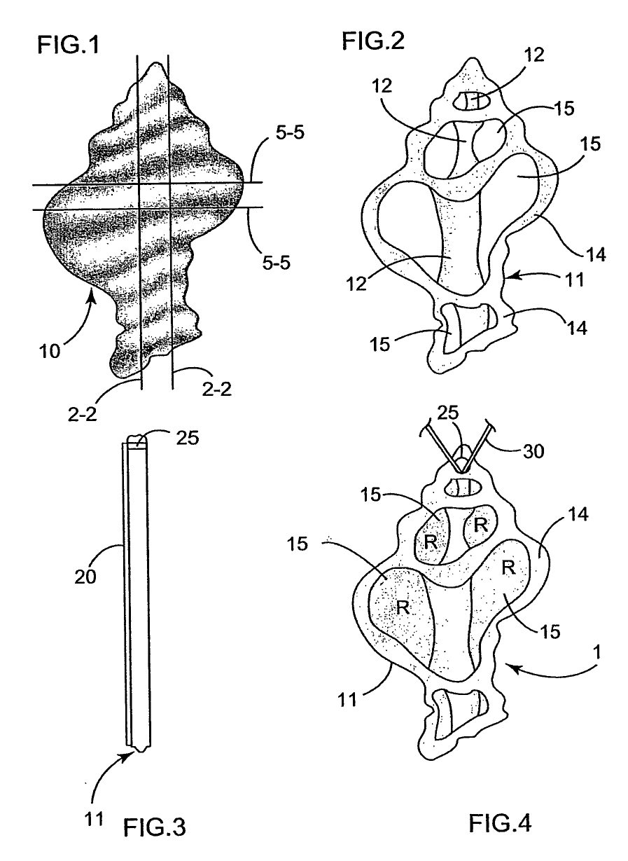

FIG. 1, a frontal view of a first kind of shell adapted to be transformed into a decorative object, for example a pendant, by a method according to the present invention;

FIG. 2, a frontal view of a slice of said empty shell after a step of cleaning and cutting,

FIG. 3, a side view of FIG. 2,

FIG. 4, a frontal view of the decorative object after a step of filling the slice of shell of FIGS. 2 and 3 with a transparent fluid resin and a step of polishing,

FIG. 5, a top view of a slice of shell according to a second embodiment of the present invention,

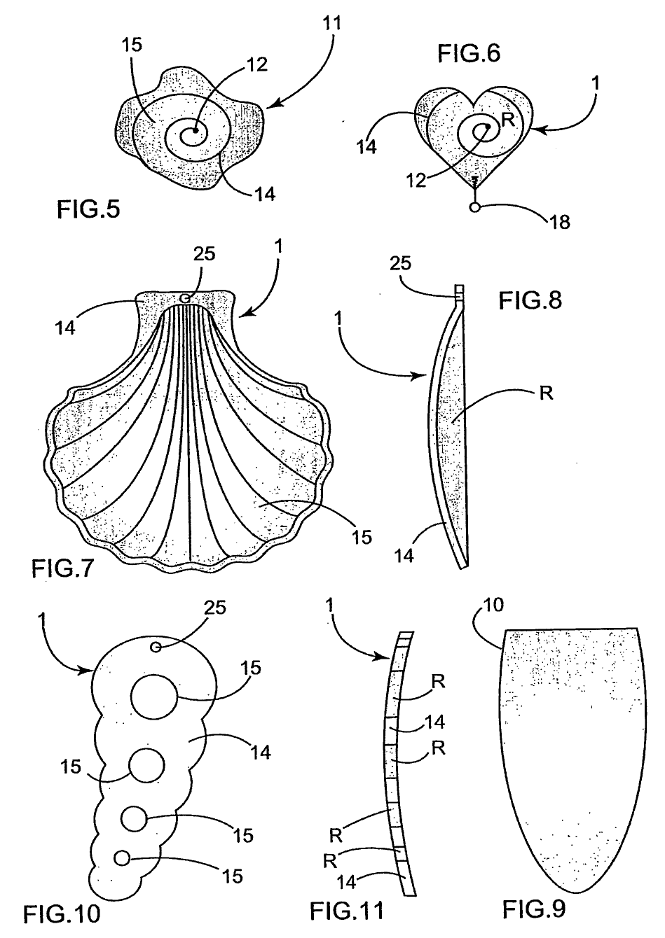

FIG. 6, a top view of the decorative object obtained after a step of filling the slice of shell of FIG. 5 with a transparent fluid resin and a step of polishing,

FIGS. 7 and 8, frontal and section views of a third embodiment according to the present invention,

FIGS. 9 to 11, frontal and section views of a fourth embodiment according to the present invention,

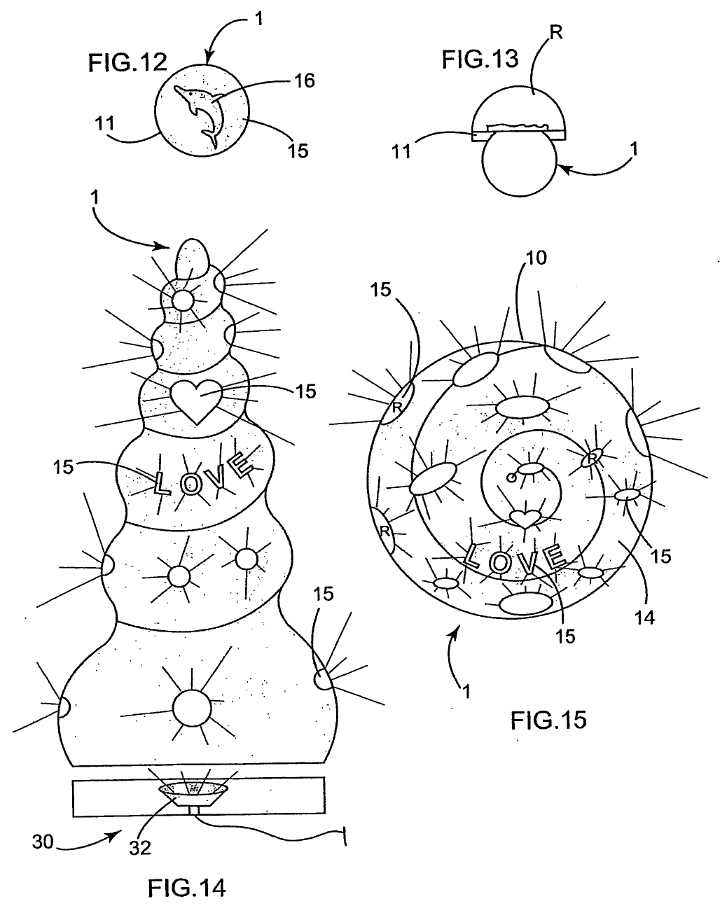

FIGS. 12 and 13, frontal and section views of a fifth embodiment according to the present invention,

FIGS. 14 and 15, frontal and section views of a sixth embodiment according to the present invention

In reference to FIGS. 1 to 4, an example of a first decorative object 1, i.e. a pendant, manufactured by a method according to the present invention is described.

This pendant 1 is based on an empty shell 10, typically an elongated mollusc like a Turitella or a Strombus granulatus Swainson, having a “central shaft” 12 (see FIG. 2 and 4) and a peripheral wall 14. The expression “central shaft” relates to the central and essentially axial part of the mollusc.

The steps for filling the shell 10 with a transparent fluid resin R to give it a particular appealing decorative effect are described below.

In a first step according to the method of the present invention, the empty shell 10 is cleaned by a known chemical and/or bacteriological treatment. The empty shell 10 can for example be immersed in a decontamination liquid pool or submitted to a cleaning spray so as to withdraw any kind of micro organisms, bacteria and/or plants stuck outside or inside said shell.

Then, in a second step according to the method of the present invention, the empty cleaned shell 10 is cut at least once, essentially longitudinally along its central shaft 12 (see lines 2-2 of FIG. 1), so as to obtain a slice of shell 11 (see FIG. 2) having a width of about 1 millimetre to several centimetres, said slice 11 embedding essentially the whole central shaft 12. Many openings 15 are thus defined around the central shaft 12, between said central shaft 12 and the peripheral wall 14. The shell 10 can for example be cut by laser, a micro saw or a water jet cutting process.

In a third step according to the method of the present invention, the openings 15 of the slice of shell 11 are at least partially closed by a cover layer 20 made for example of a woven fabric coated with an adhesive. The cover layer 20 must resist to the melt temperature of the transparent fluid resin used in the process, which is comprised between 40 to 400° C. At least one filling port or area is provided to fill the openings 15 with the transparent fluid resin R. In the present case, a complete surface of the slice of shell 11 is accessible.

In a fourth step according to the method of the present invention, a transparent fluid resin R, for example a melt of JEFFAMINE® T-403 (a polyether tri-amine sold by HUNTSMAN Petrochemical Corporation) and EPIKOTE® 828 (a liquid epoxy resin sold by RESOLUTION) is poured in the slice of shell 11 through the filling port, by a common mean such as a cup, or a bowl. The transparent fluid resin is retained by the cover layer 20 to prevent it from leaving the slice of shell 11, and it flows in every opening 15 of the slice of shell 11, preferably without any bubbles.

In a fifth step according to the method of the present invention, the slice of shell 11 is put inside a dry stove (not described) during about 12 hours, at a temperature of about 80°, so that the transparent fluid resin R can harden. Dry air can be used inside the stove to accelerate the hardening of the transparent fluid resin R in the openings 15.

In a sixth step according to the method of the present invention, the cover layer 20 is withdrawn from the stove when the transparent resin R is hard enough.

In a seventh step according to the method of the present invention, the slice of shell 11 is polished manually and/or mechanically several times to be externally as smooth as possible, for example with a polishing machine, grinding stones, polish roller, sand paper or abrasive cloth roller. The aim of this step is to withdraw any external roughness, especially if some resin has moved away from the openings so as to protrude from the shell, and to give the decorative object 1 its final shape and aspect.

After polishing externally the slice of shell 11, the decorative object 1 is thus obtained in which the transparent resin R is merged within the shell, insides the openings 15. The chosen resin R is in this case totally transparent, so that it is possible to see clearly through it. In particular, it is possible to see the internal structure of the shell, for example the central shaft 12. This effect is particularly interesting, attractive and new for this kind of objects. A hole 25 is drilled trough the hard resin and/or the shell 10 to put a necklace 30 for a pendant or to make ears.

A second embodiment according to the present invention is shown in reference to FIGS. 5 and 6. In this embodiment, the empty and cleaned shell 10 of FIG. 1 is cut across and essentially perpendicular to the central shaft 12 (see line 5-5 of FIG. 1), so as to obtain a somehow round slice 11 provided with a helical wall 14. This helical wall 14 and the central shaft 12 define a helical opening 15 disposed around the central shaft 12. The transparent fluid resin R is poured inside the opening 15 of the slice of shell in the same manner as above. When the transparent resin R has totally hardened, the slice of shell 11 is mechanically and manually polished, as described above, but it is possible to give it a special shape to make it more attractive, for example a heart or another geometrical pattern (see FIG. 6). A support means, like a hook 18, can be embedded in the transparent resin R before it becomes too hard, or screwed in the resin when it is hard enough. This hook 18 can be placed at an end of the decorative object, and used in combination with a necklace or attached to a pen, a bag, a belt, shoes, a bracelet, or any kind of fashion accessory. Of course, because of the transparency of the resin, the whole internal structure of the shell is visible.

A third embodiment according to the present invention is shown in reference to FIGS. 7 and 8. In this embodiment, the base shell is a half scallop-shell provided with a large concave opening 15, or cavity, defined by the concave wall 14 of the shell. The first step of cleaning is the same as above. The edge of the half scallop-shell can be cut and/or slightly polished if needed. Manufacturing the final decorative object 1 as represented is very simple. The cleaned empty shell is totally immersed in a transparent fluid resin pool (not shown) so that said resin R can fill the concave opening 15. When the transparent resin R becomes hard enough, the shell 10 is then withdrawn from the resin pool and polished in order to withdraw the hard resin which is stuck to the shell or has ran over the concave opening 15. At the end of this step, the concave opening 15 of the half scallop-shell is filled with the transparent resin R so has to give the object 1 a particularly eyed-catching ornamental effect because of the transparency of the resin R. A hole 25 is drilled trough the hard resin and/or the shell to put a necklace or any support means, for example to make ears.

A fourth embodiment according to the present invention is shown in reference to FIGS. 9 to 10. In this embodiment, a mother-of-shell 10 (see FIG. 9) is taken as the base shell to obtain the final decorative object. This can for example be a mother-of-pearl shell 10, thus slightly flat. After cleaning the natural shell, several holes 15 are drilled through the whole width of the shell wall 14. Then, the drilled shell 10 is immersed in a translucent and coloured fluid resin pool to fill the openings 15, or the openings 15 are partially closed by a cover layer 20 before being filled with the fluid resin R, as already described above. When the resin is totally hard, the mother-of-pearl shell 10 is then polished to give it an attractive shape, like a kind of bird feather for example. A hole 25 can also be drilled at one end of the decorative object 1 so as to make a beautiful, very unique and original pendant or ears.

A fifth embodiment according to the present invention is shown in reference to FIGS. 9, 12 and 13. In this embodiment, the mother-of shell 10 of FIG. 9 is cleaned and cut so as to form a small slice 11, i.e. a disc, having a diameter of about 5 mm to 2 cm. Then, the disc 11 is engraved in two dimensions with a mini drill or by laser, so as to create a very detailed pattern, like a dolphin 16 in the present example. The opening 15 is considered to be the part of the shell that has been removed by the erosion step, i.e. around the dolphin 16. The disc 11 is then immersed in a transparent fluid resin pool (not shown), place in a dry air stove to harden the resin and polished to create a dome shape of hard transparent resin above the dolphin. Then, the disc can be mounted on a ring provided with a kind of cameo.

A sixth embodiment according to the present invention is shown in reference to FIGS. 13-14. In this embodiment, a large shell 10, like the shell of FIG. 1, is used. This shell 10 can for example be 10-20 cm high with a base of about 5-10 cm of circumference. Many holes 15 are drilled through the wall 14 of the shell; it is even possible to drill letters to form a word like “LOVE”, or any geometrical and/or ornamental pattern like a heart. The method for obtaining the final decorative object 1 is the same as before. The final decorative object 1 can be placed around a bulb 32 (cold light) of a luminous support 30 so that the ray of lights can go out of the holes filled with the transparent or translucent resin R, providing a really astonished and decorative effect because of the light rays and the resin.

The invention is not limited to the embodiments described and represented.

For example, it is possible to use glass or crystal as a fluid material. The invention is not limited to the type of resin melt chosen in the disclosure; any type of transparent or translucent resin can be used.

It also is possible to use a coloured resin, or a translucent resin, or even a totally opaque resin in some cases. A watered effect is possible too. It is also possible to create decorative bubbles in the resin or the glass, by blowing air in a pipe or a straw introduced in the fluid material before it hardens. The surface of the resin/glass can also be sand blasted to make another visual effect.

The decorative object can also be used in house accessories, for example in the bathroom (door knob, soap support), in an office (for a pen, to make a paperweight), in a bedroom (furniture knob, wind-chime, lamp).

The shell can be replaced by lobster claws or a sea urchin.

1. A method for manufacturing a decorative object by filling at least one opening of a natural empty shell with a fluid material adapted to harden, like a polymer resin, glass or crystal, said method comprising at least the steps of:
cleaning the shell,
filling the opening(s) with said fluid material,
waiting for the fluid material to harden,
polishing the shell so as to withdraw any external roughness.

2. Method according to claim 1, wherein the shell is submitted to a bacteriological and/or chemical treatment during the cleaning step.

3. Method according to claim 1, wherein, before filling the opening(s) with the fluid material, the shell is cut and/or openings are drilled in/through the shell so as to obtain a predetermined shape.

4. Method according to claim 3, wherein openings are engraved on the shell to form a geometric pattern like letters, numbers or the shape of an object or an animal.

5. Method according to claim 4, wherein the openings are done with a mini drill, a micro saw, laser, sand blasting erosion or water jet cutting.

6. Method according claim 3, wherein, the empty cleaned shell having a central shaft:
the shell is cut so as to create a slice provided with openings, and
said openings of the slice of shell are filled with the fluid material.

7. Method according to claim 6, wherein the shell is cut longitudinally along said central shaft so as to create a slice embedding said central shaft and provided with openings disposed around the central shaft, between said central shaft and a peripheral wall.

8. Method according to claim 6, wherein the shell is cut across said central shaft, preferably essentially perpendicularly, so as to create a slice having a hollow helical shape with a helical opening defined between the central shaft and a peripheral helical wall.

9. Method according to claim 6, wherein the slice is put into a fluid material pool so that the opening(s) is (are) filled with said fluid material, and the slice is withdrawn from the pool after solidification of the fluid material.

10. Method according to claim 6, wherein:
the opening(s) is (are) sealed temporarily by a cover layer made of a material which can resist to the melt temperature of the fluid material, at least one filling port being provided in the shell for filling the opening(s) with the fluid material,
the fluid material is poured in the shell through said at least one port, and
said cover layer is withdrawn after solidification of the fluid material.

11. Method according to claim 10, wherein said cover layer is an adhesive film, a coated woven/unwoven fabric, or paper.

12. Method according to claim 1, wherein, the shell having the shape of a half scallop-shell provided with one large concave opening:
the fluid material is filled in the opening by putting said shell into a fluid material pool, and
the shell is withdrawn from the pool after solidification of the fluid material.

13. Method according to claim 1, wherein the shell is externally polished so as to provide a particular decorative and/or geometrical shape, like a heart.

14. Method according to claim 1, wherein the step of polishing is made manually or mechanically, with a polishing machine, grinding stones, polish roller, sand paper or abrasive cloth roller.

15. Method according to claim 1, wherein, in order to accelerate the step of hardening of the fluid material, the shell is put inside a stove at about 60-100° C., preferably 80° C., during approximately 8 to 14 hours, preferably 12 hours.

16. Method according to claim 15, wherein dry air is blown inside the stove.

17. Method according to claim 1, wherein the shell is provided with a support mean for a necklace.

18. Method according to claim 17, wherein the support mean is a hole drilled through the shell and/or the hardened material.

19. Method according to claim 17, wherein the support mean is a hook embedded in the hardened material.

20. Method according to claim 1, wherein said fluid material is translucent or totally transparent, so that it is possible to see clearly through said material, especially to see the structure of the shell.

21. Method according to claim 20, wherein said fluid material is a transparent polymer resin, for example a melt of a polyether tri-amine, like JEFFAMINE® T-403 and a liquid epoxy resin like EPIKOTE® 828.

22. Method according to claim 19, wherein the fluid material is glass or crystal.

23. Method according to claim 1, wherein the decorative object is a jewel like a pendant, a ring, ears or a bracelet,

24. Method according to claim 1, wherein the decorative object is a house accessory like a door knob, a lamp, a wind chime.

25. Method according to claim 1 wherein the decorative object is a fashion accessory adapted for example to be mounted on a shoe, a bag, a backpack, or a belt.

26. Decorative object obtained by a method according to claim 1 and comprising a shell provided with at least one opening filled with a fluid material adapted to harden when cold such as a resin, glass or crystal.
